(19) United States
(12) Patent Application Publication
(10) Pub. No.: US 2005/0117798 A1
(43) Pub. Date: Jun. 2, 2005

(54) Method and apparatus for modifying a portion of an image frame in accordance with colorimetric parameters

(75) Inventors: David L. Patton, Webster, NY (US); John R. Fredlund, Rochester, NY (US); John D. Buhr, Newton, PA (US); Carlo V. Hume, Fairport, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/726,253

(22) Filed: Dec. 2, 2003

(51) Int. Cl. G06K 9/00

(52) U.S. Cl. 382/167

(57) ABSTRACT

A method for modifying at least one calorimetric attribute of a predetermined region (22,24) of a motion picture frame (20) in which metadata associated with the motion picture frame (20) is provided, the metadata defining the predetermined region (22,24) of the frame (20). A colorimetric transform is applied to pixels within the predetermined region (22,24), modifying the at least one colorimetric attribute thereby.

### CROSS-REFERENCE TO RELATED APPLICATION(S)

Reference is made to commonly assigned copending application Ser. No. 10/401,923, entitled “Method and System for Modifying Digital Cinema Frame Content” and filed on 28 Mar. 2003 in the names of David L. Patton, Dale McIntyre, John R. Fredlund, Michael E. McCrackan, Carlo V. Hume, and Arthur J. Cosgrove.

### FIELD OF THE INVENTION

The present invention generally relates to colorimetric adjustment of defined areas within an image frame and more particularly relates to a color imaging system for selectively adjusting flesh tones within an image frame of a digitized motion picture in accordance with viewer preference.

### BACKGROUND OF THE INVENTION

The difficulty of capturing and reproducing accurate and pleasing flesh tones is widely recognized in the imaging arts. For example, color negative/positive photographic systems in use today are designed to produce pleasing prints for most of the people in a target population. The print appearance includes both pleasing tone and color reproduction to produce colorful prints with good contrast, and particularly excellent flesh tone reproduction. Typically, existing photo systems are designed to be optimized for a particular skin type and preference. For example film colorimetric parameters can be optimized for capture and reproduction of some segment of the full range of flesh tones of world populations, such as Caucasian, Oriental, Asian, Indian, or Black flesh tones. Necessarily, photographic film, paper, and printer sets-ups are designed for providing pleasing color for a particular market segment, having a subset of the full range of flesh tones. As a result, a system optimized for producing photographs of people who have a lighter flesh tone may yield disappointing results for producing photographs of people who have a darker flesh tone. This can be especially true for the same film type and techniques used to photograph people whose flesh tones lie on the extremes of the range. This can result in loss of overall image quality, particularly with respect to facial features.

Digital imaging now allows the capability to make colorimetric adjustments that can compensate for local differences in flesh tone reproduction. With digital images, such as those obtained from a digital camera or from a scanned print, colorimetric response of an imaging or display system can be adapted to allow an operator or consumer to modify flesh tone reproduction in order to provide a more pleasing output. For example, commonly assigned U.S. Pat. No. 6,396,599 (Patton et al.) entitled “Method and Apparatus for Modifying a Portion of an Image in Accordance with Colorimetric Parameters” discloses a system that locates a flesh tone area in an image and allows an operator to adjust calorimetric attributes of that area in order to provide a more satisfactory output image. Colorimetric analysis and various supporting tools such as face recognition algorithms can be employed with such a technique in order to provide efficient identification of flesh tones in a scanned print or digital camera image.

While methods such as those of the Patton et al. '599 disclosure present capable solutions for handling individual photographic images, the problem of flesh tone adaptation in motion picture imaging is more difficult. In conventional motion picture film processing, various editing procedures may be executed on a digitized image, scanned from the original film shot at the studio. After editing, the final image can then be rewritten onto a print film for distribution to local theaters and exhibitors. Thus, for conventional motion picture film production, editing personnel can perform colorimetric operations on a frame-by-frame basis, using the scanned digital image data. Using a sequence of frame image digitization, object and outline detection and masking, selective calorimetric modification, and printing to film, it is possible for editing personnel to adjust or to add color in successive frames of a conventional film motion picture. This overall sequence is used, for example, in colorization of black-and-white motion picture film, using techniques such as those disclosed in U.S. Pat. Nos. 5,912,994 (Norton et al.); 5,050,984 (Geshwind); and 3,784,736 (Novak).

The introduction of digital cinema is expected to bring about numerous changes in how motion pictures are produced and distributed. Referring to FIG. 1, there is shown a block diagram of a digital cinema preparation and distribution system 100 for providing motion picture images from a studio 110 to a post production facility 111, which digitizes the motion picture images and provides the digitized images over a transmission system 130 to an exhibition system 140, typically a movie theater. (The post production facility 111 may be under the control of the studio 110, or it may exist (as it typically would) as a separate entity in the overall system 100.) At post production facility 111, digital mastering is performed on film 112 that contains image content, such as the film feature, advertising, trailers, and the like. A datacine system 114 transforms the film content into digital image content and provides the digital image content to a rendering system 118, typically supported by a disk array 120, that renders the motion picture image data in a resolution suitable for distribution and display. Rendering system 118 may also accept input from auxiliary input devices 116 such as data tape, D5 video tape, and DataCam devices. The fully mastered digital cinema output then is provided as a data stream to transmission system 130, which may utilize a satellite 138 in communication with a transmitter 122 connected to post production facility 111 equipment. Other alternative transmission media include a fiber cable connection 136, or transmission using an optical medium 134, such as DVD or optical disks, or using a magnetic medium 132, such as data tape. At exhibition system 140, the mastered digital image data is received, such as at a receiver 148, an optical media reader 144, a magnetic media reader 142 or over a data or fiber optic cable connection 136. A cinema operating system 146, typically supported by disk array 120, accepts the digital input data, processes the input data stream for presentation, and provides this data for image forming and projection by one or more digital projectors 150.

As the data path of FIG. 1 shows, digital cinema affords expanded opportunities for colorimetric manipulation of both a motion picture feature and its accompanying promotional content, such as advertising and trailers shown before or after the film. Certainly, a cinematographer, particular about achieving an artistic effect with a motion picture feature, may be sensitive to allowing adjustment of flesh tone or other colorimetric parameters by others at various points in the digital image data distribution stream or may want to put strict limits on such adjustments. An advertiser, on the other hand, may find it particularly desirable to adjust colorimetric attributes of advertising or trailer content to obtain broader and more effective distribution. For example, it may be of perceived benefit to a soft drink advertiser to distribute identical promotional image content to numerous sites, while allowing the operator at each site to adjust flesh tone or other colorimetric characteristics that appear within motion picture frames. Thus, the same commercial image content, playing at opposite corners of the world, can be given entirely different skin coloring at each projection site.

Thus, what is needed is an apparatus and method for selectively adjusting the calorimetric attributes of flesh tone or changing other local color characteristics within an image frame of a digitized motion picture.

### SUMMARY OF THE INVENTION

It is an object of the present invention to allow the modification of flesh tones, or of other selectable color areas, of a digital motion picture. With this object in mind, the present invention provides a method for modifying at least one colorimetric attribute of a predetermined region of a motion picture frame comprising:
(a) providing metadata associated with the motion picture frame, said metadata defining the predetermined region of the frame; and
(b) applying a calorimetric transform to pixels within the predetermined region, modifying the at least one calorimetric attribute thereby.

It is a feature of the present invention that it employs colorimetric transforms to modify selected portions of successive motion picture image frames in order to adapt the color of objects in the motion picture to specified preferences.

It is an advantage of the present invention that it allows color modification of image data at more than one point in the motion picture production chain.

It is a further advantage of the present invention that it allows a local exhibitor to adapt colorimetric characteristics of flesh tones to suit local preferences. This capability can also be extended to other identified objects in the motion picture frame.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic block diagram of a digital cinema preparation and distribution system.

FIG. 2 is a plane view showing an example image frame having areas requiring calorimetric modification.

FIG. 3 is a plane view showing how masks and/or coordinates can be used to specify image frame areas that are candidates for calorimetric modification.

FIG. 4 is a schematic block diagram showing a colorimetric modification display apparatus of the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

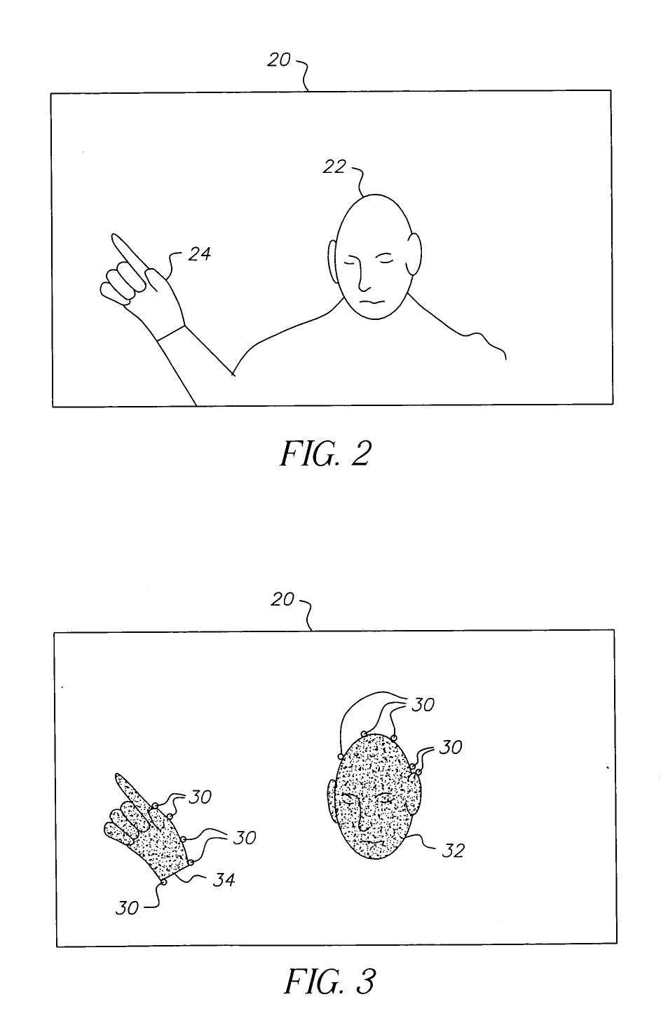

Referring to FIG. 2, there is shown a sample image frame 20 within a sequence of image frames for a digital motion picture. The digital motion picture may be a feature film or may have promotional content, such as a trailer or advertising, for example. Within image frame 20 are two flesh tone regions 22, 24. As was noted in the background, it can be desirable to modify flesh tone regions 22, 24 in order to be more appealing to a local audience.

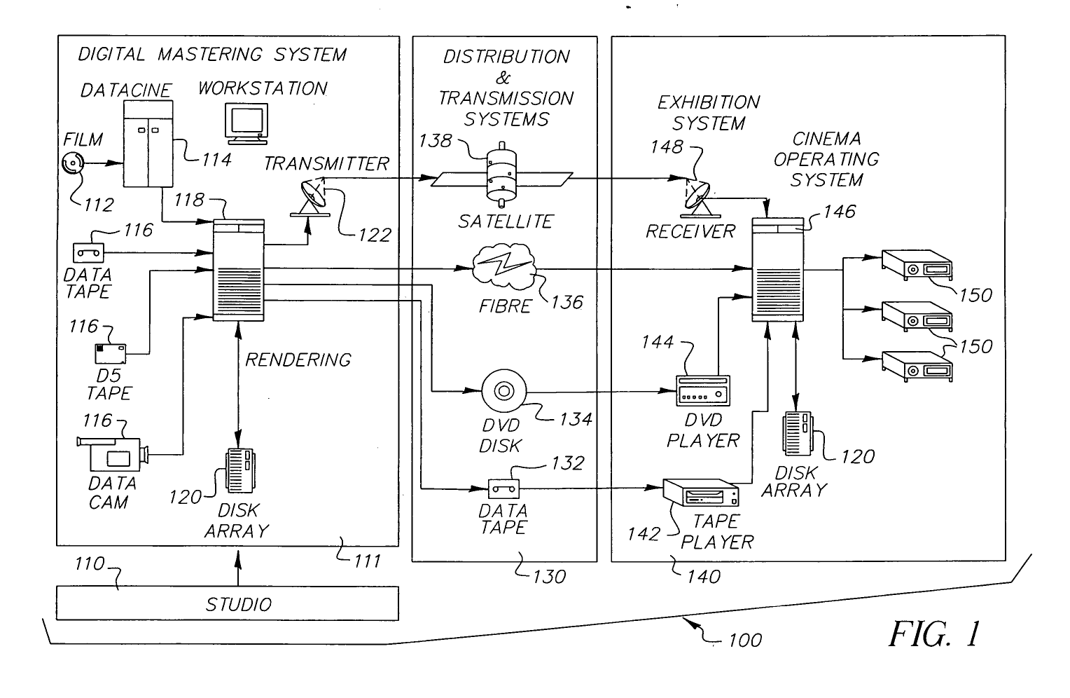

With digital cinema, it is possible for studio 110 (FIG. 1) to provide some amount of metadata corresponding to each image frame 20. Such metadata may refer without limitation to such areas or regions as flesh tone areas, hair color areas, eye color areas, and such other scene areas as grass and sky, and the presently-described algorithm may be used to modify a calorimetric attribute of such areas. For these areas, such as a flesh tone area, this metadata would include information identifying the area in some way. Referring to FIG. 3, there are shown two masks 32 and 34 that correspond to flesh tone regions 22 and 24 in FIG. 2. Metadata identifying masks 32 and 34 could be provided as bitmap data, such as in a binary form (for example, where “1” data indicates a pixel within masks 32 or 34 and “0” data indicates a pixel outside these regions). Alternately, metadata could simply give coordinates 30 that define the outline of flesh tone regions 22 and 24; FIG. 3 shows a few coordinate 30 points by way of example. Metadata could be provided in tabular form, as is shown in the simplified example of Table 1.

With respect to the digital image data stream, metadata could be supplied using the same communications channel used for the digital cinema content. Metadata might be interleaved with image data or provided before or after image content. Alternately, image data and metadata could be provided using separate data channels.

TABLE 1
Metadata Example for Successive Image Frames 20

| Frame # | Object | Bounding coordinates |
|---|---|---|
| 8043 | Flesh tone area, face, male | (137, 144) |
| | | (433, 158) |
| | | (501, 199) |
| | | (658, 247) |
| | | (661, 398) |
| | | (140, 387) |
| 8044 | Flesh tone area, face, male | (138, 112) |
| | | (440, 208) |
| | | (511, 239) |
| | | (677, 267) |
| | | (691, 404) |
| | | (138, 415) |
| 8045 | Flesh tone area, face, male | (138, 111) |
| | | (444, 208) |
| | | (511, 259) |
| | | (688, 267) |
| | | (706, 411) |
| | | (138, 415) |

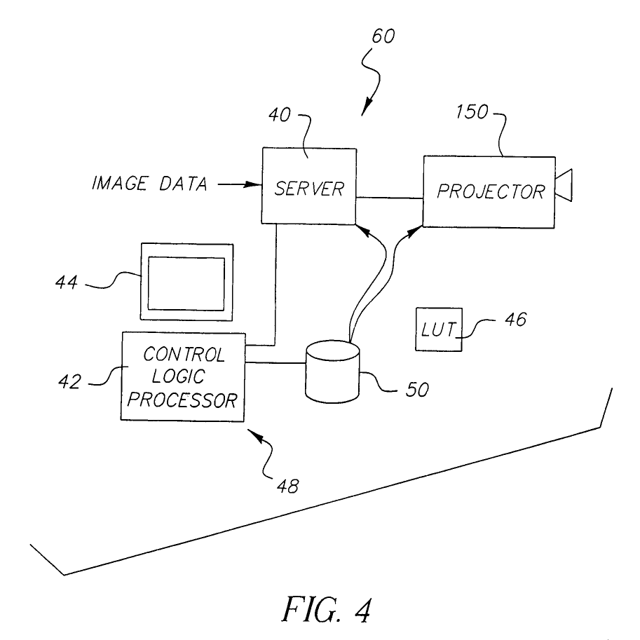

Referring to FIG. 4, there is shown an image modification and display apparatus 60 for altering flesh tones or other color areas of digital cinema content at the exhibition site according to the present invention. As was shown in FIG. 1, image data is provided to a server, which is identified in FIG. 4 as server 40, that is at, or communicates with, digital projector 150 at the local exhibitor site. Also provided to server 40 is the metadata identifying flesh tone areas or other areas to be modified. A control logic processor 48, such as a dedicated computer workstation 42 with an optional display monitor 44, maintains an optional library 50, which can be a database of color transform Look-Up Tables, LUTs 46. For modifying the identified flesh tone areas in a frame 20, control logic processor 48 selects an appropriate LUT 46 supplied to server 40 for use in the image data path. Alternately, LUT 46 may be provided directly to digital projector 150 for processing pixels within masks 32, 34 (FIG. 3) or other identified regions. LUT 46 may be applied to the identified image data “on the fly” as it is being received or as it is being projected, or may be applied to stored image data maintained by server 40. The task of applying LUT 46 or other suitable transform may be performed within server 40 or within projector 150, depending on the processing capability available at either device. It must be noted that the configuration of FIG. 4 shows only one possible embodiment; there are numerous possible arrangements that could combine the functions of server 40 and projector 150 for providing the necessary image processing, including application of LUTs 46 and related transforms.

Control logic processor 48 may provide an operator with the option to select attributes of the color transform used as LUT 46. Alternately, LUT 46 itself could be provided or specified along with the metadata for use by server 40. For example, an advertising distributor may decide to automatically download as metadata or specify a LUT 46 suitable for flesh tone modification when the advertising content is shown in any region of the world. In this way, a different LUT 46 can be applied to the same image data, depending on where content is shown, allowing suitable flesh tone transforms to be applied for the same content whether it is displayed in India, Brazil, or Finland, for example.

The listing of Table 1 is intended to be illustrative only; alternate and/or additional metadata fields could be provided for identifying an area of frame 20 that can be modified using alternate calorimetric transforms. The data format of the metadata could be a simple, open data format, such as employing familiar comma-separated fields, for example. More complex encoding schemes could be used, such as those employing compression, security algorithms wherein a key is required for decoding, or other known mechanisms for data transfer.

Methods for applying LUT 46 as a colorimetric transform are well known in the art. It must be emphasized that other types of calorimetric transforms and algorithms based on, e.g., multi-dimensional (e.g., 3D) look up tables, matrices, and so on, are available for modifying color characteristics of an area of an image, well known to those skilled in the color imaging arts. Furthermore, a transform or algorithm may be selected for application to the whole image, if the transform or algorithm would primarily change skintones within the frame, and only slightly affect other tones and colors. In effect, in that case, the calorimetric transform is applied to pixels within the whole frame.

In an alternate embodiment, studio 110 does not provide metadata defining flesh tone regions 22, 24 or other areas of frame 20 that may be subject to colorimetric transform. Instead, local exhibitor at exhibition system 140 may apply various types of imaging algorithms for detecting flesh tone regions 22, 24 in the received image data. Utilities such as skin tone and facial feature recognition algorithms, well known in the imaging arts, could be used to identify flesh tone regions 22, 24 in order to allow LUTs 46 or other suitable transforms to be applied.

It must be re-emphasized that the specification of the present disclosure describes modification of flesh tone regions 22 and 24, as were shown in the examples of FIGS. 2 and 3. However, it can be appreciated that the method of the present invention need not be confined to flesh tones, but can be more broadly applied to other types of colored regions or objects in a motion picture image frame. For example, there may be reasons to emphasize or to de-emphasize certain colors or objects for special effects with some audiences. Hair color or other features could also be changed using the basic methods of the present invention.

Metadata provided for flesh tone regions 22, 24 or for other areas of image frame 20 may alternately specify limits or boundary values for LUT application to these regions. In this way, for example, the range of flesh tone selections for one or more actors could be restricted in order to prevent unrealistic treatment. This would allow some measure of control of the skin tone range by studio 110.

Using the method of the present invention, studio 110 could provide exhibition system 140 with image data that is intended to be used as a type of master motion picture. LUTs or other suitable transforms could then be provided along with the metadata from studio 110 or may be provided to exhibition system 140 by some other transmittal means. It is then the function of the exhibitor to ensure that the master motion picture is suitably treated at the exhibition site before projection.

Also using the method of the present invention, a single frame can be modified or the modification can be applied to a set of consecutively displayed motion picture frames, as would often be the case in a motion picture modification. In the latter case, it is important that the calorimetric adjustments from one frame to the next are done in a consistent manner for objects persisting from one frame to the next. As an example, for the best results for skintone reproduction of different races, different transforms might be used for humans in each frame having different skintones (e.g., asian, Caucasian, or african-american skintones, and so on). It would be important for each human in successive frames to be adjusted in the same way or a person's reproduction could shift from frame to frame. This is an additional desirable constraint, since it could be difficult if a facial recognition algorithm, or a skintone recognition algorithm, were to be used unless these algorithms were capable of identifying specific individual skintone types.

The transforms used to modify the imagery in selected areas need not be limited to color transformations. Other modifications to the imagery can be supported, e.g., transformations that would affect sharpness, tonescale, color balance, and the like. For example, if an undesirable object, such as an advertisement, is present in the scene and there is a desire to obscure the object, a transform may be applied which blurs the selected pixels representing the object. This technique may also be used to obscure, i.e., unsharpen or throw out of focus, distracting objects and faces. For example, this may be especially useful for providing a more enjoyable viewing experience of an image of an emphasized person or couple, such as a bridal couple, if other faces in the image are deemphasized. In general, such a method modifies at least one attribute of an object by the steps of (a) providing metadata defining a predetermined region containing the object; and (b) applying a transform to pixels within the predetermined region, thereby modifying the attribute of the object whereby the object is treated differently relative to other objects in the frame.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, various types of imaging transforms could be applied at different stages of production for digital motion picture content, in addition to the LUTs 46 described. The method of the present invention could be applied in preparation of conventional film-based motion pictures, but would be applied at an editing facility, allowing distribution of the same image content having different colorimetric transforms applied to suit local/regional preferences.

Thus, what is provided is an apparatus and method for selectively adjusting flesh tones or other areas within an image frame, or to an entire image frame, of a digitized motion picture in accordance with viewer preference.

### Parts List

20 Image frame
22, 24 Flesh tone regions
30 Coordinates
32, 34 Masks
40 Server
42 Workstation
44 Display monitor
46 Look-Up Table (LUT)
48 Control logic processor
50 Library
60 Image modification and display apparatus
100 Digital cinema preparation and distribution system
110 Studio
111 Post production facility
112 Film
114 Datacine system
116 Auxiliary input devices
118 Rendering system
120 Disk array
122 Transmitter
130 Transmission system
132 Magnetic medium
134 Optical medium
136 Fiber cable connection
138 Satellite
140 Exhibition system
142 Magnetic media reader
144 Optical media reader
146 Cinema operating system
148 Receiver
150 Digital projector

1. A method for modifying at least one colorimetric attribute of a predetermined region of a motion picture frame comprising:
(a) providing metadata associated with the motion picture frame, said metadata defining the predetermined region of the frame; and
(b) applying a calorimetric transform to pixels within the predetermined region, modifying the at least one colorimetric attribute thereby.

2. A method for modifying at least one calorimetric attribute according to claim 1 wherein said predetermined region comprises an area having a flesh tone.

3. A method for modifying at least one colorimetric attribute according to claim 1 wherein said predetermined region comprises an area having a hair color.

4. A method for modifying at least one calorimetric attribute according to claim 1 wherein said predetermined region comprises an area having an eye color.

5. A method for modifying at least one colorimetric attribute according to claim 1 wherein the step of providing metadata comprises the step of providing coordinates within the motion picture frame.

6. A method for modifying at least one colorimetric attribute according to claim 1 wherein the step of applying a calorimetric transform comprises the step of applying a look-up table.

7. A method for modifying at least one colorimetric attribute according to claim 1 further comprising the step of displaying the motion picture frame having said modified at least one colorimetric attribute.

8. A method for modifying at least one colorimetric attribute according to claim 7 wherein the step (b) of applying the colorimetric transform is done during the step of displaying.

9. A method for modifying at least one colorimetric attribute according to claim 1 wherein the step of applying a colorimetric transform comprises the step of conforming within predetermined limits for flesh tones, said predetermined limits specified in said metadata.

10. A method for modifying at least one calorimetric attribute according to claim 6 wherein said look-up table is specified in said metadata.

11. A method for modifying at least one colorimetric attribute according to claim 1 further comprising the step of storing the motion picture frame that was modified by applying the colorimetric transform to pixels thereof.

12. A method for modifying at least one colorimetric attribute according to claim 11 wherein the step of storing is performed at a motion picture exhibition site.

13. A method for modifying at least one colorimetric attribute according to claim 1 wherein the motion picture frame is one of a set of consecutively displayed motion picture frames and the modification generated in step (b) is obtained by applying the calorimetric transform to pixels within the set of frames.

14. A method for modifying at least one colorimetric attribute according to claim 13 wherein objects persist from one frame to the next and the modification generated in step (b) is applied consistently across the frames to the same objects.

15. A method for modifying at least one colorimetric attribute according to claim 1 wherein the colorimetric transform is applied to pixels within the whole motion picture frame.

16. A method for modifying an original flesh tone in a set of consecutively displayed digital motion picture frames to provide a modified flesh tone, the method comprising, for each frame in the set:
(a) obtaining image data for the frame;
(b) identifying at least one area in the frame having the original flesh tone;
(c) applying a calorimetric transform to said at least one area to modify the original flesh tone over said at least one area and obtain the modified flesh tone; and
(d) incorporating image data for the modified flesh tone into the frame, forming a modified frame thereby.

17. A method for modifying an original flesh tone according to claim 16 further comprising the step of displaying said modified frame.

18. A method for modifying an original flesh tone according to claim 16 wherein said calorimetric transform comprises a LUT.

19. A method for modifying an original flesh tone according to claim 16 wherein the step of identifying each area in the frame having the original flesh tone comprises the step of forming a bit-mapped mask for at least one said area.

20. A method for modifying an original flesh tone according to claim 16 wherein the step of identifying each area in the frame having the original flesh tone comprises the step of providing a set of positional coordinates for at least one said area.

21. A method for modifying an original flesh tone according to claim 16 wherein objects persist from one frame to the next and the modification generated in step (c) is applied consistently across the frames to the same objects.

22. A method for modifying an original flesh tone according to claim 16 wherein the step of identifying each area in the frame having the original flesh tone comprises the step of applying a skin tone recognition algorithm to said image data.

23. A method for modifying an original flesh tone according to claim 16 further comprising the step of storing said modified frame.

24. A method for modifying an original flesh tone according to claim 23 further comprising the step of storing said modified frame at a motion picture exhibition site.

25. A method for modifying an original flesh tone according to claim 16 further comprising the step of transmitting said modified frame to an exhibition site.

26. A method for modifying an original flesh tone according to claim 16 wherein the step of identifying said at least one area in the frame having the original flesh tone comprises the step of applying at least one of a skin tone algorithm or a facial recognition algorithm to said image data.

27. A method for modifying at least one colorimetric attribute of a predetermined region of a motion picture frame comprising:
(a) preparing a master motion picture frame having said predetermined region;
(b) generating metadata identifying said predetermined region;
(c) transmitting said master motion picture frame and said metadata to an exhibition site; and
(d) applying a colorimetric transform at the exhibition site to pixels of said master motion picture frame within said predetermined region, thereby modifying the at least one colorimetric attribute.

28. A method for modifying at least one colorimetric attribute of a predetermined region of a motion picture frame according to claim 27 further comprising the step of displaying a modified master motion picture frame.

29. A method for modifying at least one calorimetric attribute of a predetermined region of a motion picture frame according to claim 27 wherein the step of preparing a master motion picture frame having metadata comprises the steps of
(a) identify said predetermined region by processing a master motion picture frame and generating said metadata identifying said predetermined region; and
(b) associating said metadata with said master motion picture frame.

30. A method for modifying at least one colorimetric attribute of a predetermined region of a motion picture frame according to claim 29 wherein the step of processing said master motion picture frame comprises the step of applying a recognition algorithm to said pixels of said master motion picture frame.

31. A method for modifying at least one colorimetric attribute of a predetermined region of a motion picture frame according to claim 27 wherein the step of applying a colorimetric transform requires an operator selection from a plurality of available calorimetric transforms.

32. A method for modifying at least one calorimetric attribute of a predetermined region of a motion picture frame according to claim 27 further comprising the step of storing the motion picture frame that was modified at the exhibition site.

33. A method for modifying an original flesh tone in a set of consecutively displayed digital motion picture frames to provide a modified flesh tone, the method comprising:
(a) processing said set of consecutively displayed digital motion picture frames to generate metadata identifying areas having the original flesh tone;
(b) transmitting, to an exhibition site, a master motion picture comprising said set of consecutively displayed digital motion picture frames and said metadata;
(c) Receiving said master motion picture and said metadata at said exhibition site; and
(d) applying a colorimetric transform to said set of consecutively displayed digital motion picture frames, according to said metadata, to modify said areas having the original flesh tone, forming a modified set of consecutively displayed digital motion picture frames thereby.

34. A method for modifying an original flesh tone in a set of consecutively displayed digital motion picture frames according to claim 33 further comprising the step of storing said modified set of consecutively displayed digital motion picture frames.

35. A method for modifying an original flesh tone in a set of consecutively displayed digital motion picture frames according to claim 33 further comprising the step of substituting said set of consecutively displayed digital motion picture frames into said master motion picture to form a modified motion picture.

36. A method for modifying an original flesh tone in a set of consecutively displayed digital motion picture frames according to claim 33 wherein the step of applying said colorimetric transform is performed during display of said modified motion picture.

37. An exhibition system for projecting a digital motion picture comprising:
(a) a server for receiving digital motion picture data;
(b) a control console for accepting, from an operator, assignment of a selected color transform to identified image frames of the digital motion picture; and
(c) a display system for obtaining the digital motion picture data from said server as a sequence of said image frames, for applying color modification data to at least a portion of each of a plurality of successive said image frames to form color-modified image frames according to said selected color transform, and for displaying said color-modified frames accordingly.

38. An exhibition system according to claim 37 wherein said color transform comprises a look-up table.

39. An exhibition system according to claim 37 wherein said selected color transform is chosen from a library of available transforms.

40. An exhibition system according to claim 37 wherein said at least a portion of each of said successive image frames is identified in metadata provided to said server.

41. An exhibition system according to claim 37 wherein said selected color transform adapts skin tone colorimetric characteristics.

42. A method for modifying at least one attribute of an object confined to a predetermined region of a motion picture frame, said method comprising:
(a) providing metadata associated with the motion picture frame, said metadata defining the predetermined region containing the object; and
(b) applying a transform to pixels within the predetermined region, thereby modifying the at least one attribute of the object whereby the object is treated differently relative to other objects in the frame.

43. A method for modifying at least one attribute of an object as claimed in claim 42 wherein the transform modifies the sharpness of the object.

44. A method for modifying at least one attribute of an object as claimed in claim 42 wherein the object is a face.
